(19) United States
(12) Patent Application Publication
(10) Pub. No.: US 2011/0027763 A1
(43) Pub. Date: Feb. 3, 2011

(54) READING EDUCATION TOOL

(75) Inventor: Jane M Tramm, Hugo, MN (US)

Correspondence Address: LEFFERT JAY & POLGLAZE, P.A., P.O. BOX 581009, MINNEAPOLIS, MN, 55458-1009, US

(73) Assignee: Harebrain, Inc, Minneapolis, MN (US)

(21) Appl. No.: 12/919,936

(22) PCT Filed: Dec. 2, 2009
(86) PCT No.: PCT/US09/66391

§ 371 Date: Aug. 27, 2010

Related U.S. Application Data
(63) Continuation-in-part of application No. 61/119,193, filed on Dec. 2, 2008.

(51) Int. Cl. G09B 1/06

(52) U.S. Cl. 434/172

(57) ABSTRACT

A reading education tool has detachable letters and/or letter combinations to be attached thereto, and can be stretched to separate the letters and/or letter combinations to enable a learner to sound out individual letters and/or letter combinations and to see the words both in a compact format and a stretched format.

### FIELD

The present disclosure relates in general to educational tools and methods, and more specifically, to tools and methods for reading education.

### BACKGROUND

Reading is a process of viewing symbols and decoding those symbols in order to derive their meaning. One common reading instruction method is referred to as phonics. Phonics involves teaching the reader to associate letters or groups of letters with a spoken sound. When an unknown word is encountered, the reader identifies the individual sounds for each letter or group of letters in the word. The individual sounds are then combined and blended together to allow the reader to identify the complete word or at least an approximation of the complete word.

### SUMMARY

In general terms, this disclosure is directed to a reading education tool. In one possible configuration and by non-limiting example, the reading education tool includes an elastic strip and a plurality of letter pieces coupled to the elastic strip. The reading education tool includes a first position and a second position. When the reading education tool is in the second position, a distance between adjacent letter pieces is greater than when the reading education tool is in the first position.

One aspect is a reading education tool comprising an elastic strip, a first letter piece, and a second letter piece. The elastic strip has a relaxed position and a stretched position. The first and second letter pieces are coupled to the elastic strip. When the elastic strip is in the stretched position, a distance between the first and second letter pieces is greater than when the elastic strip is in the relaxed position.

Another aspect a software program stored on a computer readable storage medium. The software program includes instructions executable by a processor of a computing device to generate a user interface display. The user interface display includes a visual representation of a reading education tool. The reading education tool includes a plurality of spaced letter pieces. Each letter piece is associated with at least one letter. The reading education tool includes a stretched position and a relaxed position. When the reading education tool is in the stretched position, a distance between adjacent letter pieces is greater than when the reading education tool is in the relaxed position.

Yet another aspect is a reading education method, the method comprising: arranging and connecting a plurality of letter pieces on a reading education tool while the reading education tool is in a relaxed position; stretching the reading education tool to a stretched position to increase spaces between adjacent letter pieces of the plurality of letter pieces; viewing the plurality of letter pieces while the reading education tool is in the stretched position; allowing the reading education tool to return to a relaxed position; and viewing the plurality of letter pieces while the reading education tool is in the relaxed position.

### BRIEF DESCRIPTION OF THE DRAWINGS

FIG. 1 is a front perspective view of an example reading education tool according to the present disclosure, the reading education tool being arranged in a relaxed position.

FIG. 2 is a front perspective view of the reading education tool shown in FIG. 1 in a stretched position.

FIG. 3 is an exploded front perspective view of the reading education tool shown in FIG. 1.

FIG. 4 is an exploded rear perspective view of the reading education tool shown in FIG. 1.

FIG. 5 is an exploded left side view of the reading education tool shown in FIG. 1.

FIG. 6 is a front view of an example stretchable strip of the reading education tool shown in FIG. 1 in a relaxed position.

FIG. 7 is a front view of the elastic strip shown in FIG. 6 in a stretched position.

FIG. 8 is a left side cross-sectional view of the elastic strip shown in FIG. 6.

FIG. 9 is top plan view of a plurality of example letter pieces of the reading education tool shown in FIG. 1.

FIG. 10 is a left side cross-sectional view one of the letter pieces shown in FIG. 6.

FIG. 11 is a front perspective view of another example reading education tool according to the present disclosure, including five letter pieces.

FIG. 12 is a front perspective view of another example letter piece according to the present disclosure.

FIG. 13 is a screen shot of an example user interface display of a software program according to the present disclosure including a representation of a reading education tool in the relaxed position.

FIG. 14 is a screen shot of the example user interface display of the software program described in FIG. 13 including a representation of the reading education tool in the stretched position.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

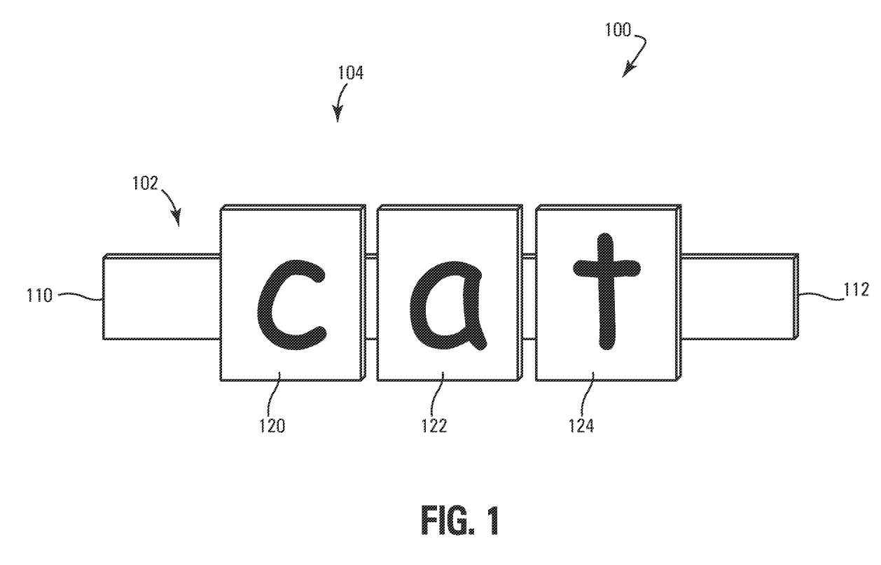

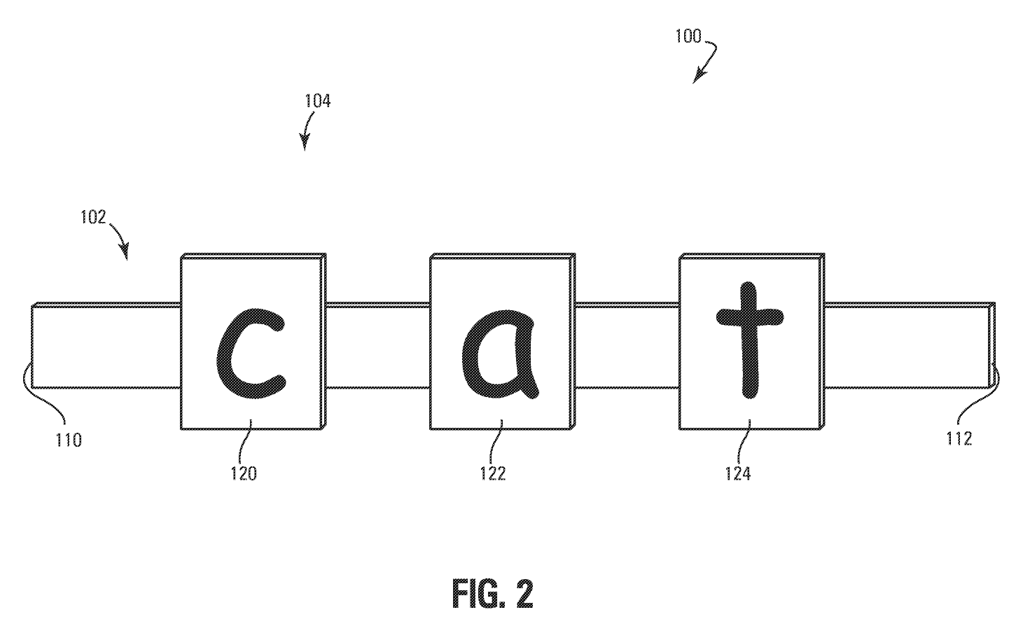

FIGS. 1 and 2 illustrate an example reading education tool 100 according to the present disclosure. FIG. 1 is a perspective front view of reading education tool 100 in a relaxed position. FIG. 2 is a perspective front view of reading education tool 100 in a stretched position.

Reading education tool 100 includes elastic strip 102 and letter pieces 104. Elastic strip 102 includes ends 110 and 112. In this example, letter pieces 104 include letter pieces 120, 122, and 124.

Elastic strip 102 is typically an elongate strip of one or more materials. Elastic strip 102 includes a first end 110 and an opposing second end 112. Elastic strip 102 can be stretched by a reader by pulling on ends 110 and 112.

Letter pieces 104 include a representation of at least one letter or symbol. In this example, reading education tool 100 includes three letter pieces 120, 122, and 124. The letter “c” is printed on letter piece 120. The letter “a” is printed in letter piece 122. The letter “t” is printed on letter piece 124. Other embodiments include other letters and letter pieces.

Some embodiments allow multiple letter pieces 104 to be connected to elastic strip 102 at a time. The quantity of letter pieces is typically in a range from about 1 to about 10, and preferably from about 3 to about 5, and more preferably from 3 to 4.

Letter pieces 104 are fastened to elastic strip 102. In some embodiments letter pieces 104 are permanently fastened to elastic strip 102, such as by thread or adhesive. In other embodiments letter pieces 104 are removably fastened to elastic strip 102, as described in more detail below.

As shown in FIG. 1, when the reading education tool 100 is in the relaxed position, letter pieces 104 are near to each other. This allows the reader to see the whole word that is formed by the letters on the letter pieces. In this example, the word is “cat”.

The letter pieces can then be separated as shown in FIG. 2. When the reader pulls on ends 110 and 112, elastic strip 102 stretches causing reading education tool 100 to be placed into the stretched position. When in the stretched position, letter pieces are separated from each other to allow the reader to more easily consider each letter of letter pieces 104. For example, after reading education tool 100 is placed into the stretched position shown in FIG. 2, the reader can then study each of the letters that make up the word individually. The reader looks to the first letter piece 120 and sees the letter “c.” The reader then determines what sound is represented by the letter “c.” Next, the reader evaluates the second letter piece 122 and sees the letter “a.” The reader then determines what sound is represented by the letter “a.” The reader then continues by evaluating the third letter piece 124 having the letter “t.” The reader determines what sound is made by the letter “t.” Once all three sounds have been determined, the user then attempts to combine all of the sounds together to pronounce the word represented by the letter pieces 120, 122, and 124. In this case, the reader determines that the word is “cat.” The reading education tool 100 is then returned to the relaxed position, where the entire word is viewed by the reader.

An advantage of some embodiments of reading education tool 100 is that reading education tool 100 does not cause letters represented by letter pieces 104 to be distorted when reading education tool advances between the relaxed and stretched positions. The letters are distortion free in some embodiments.

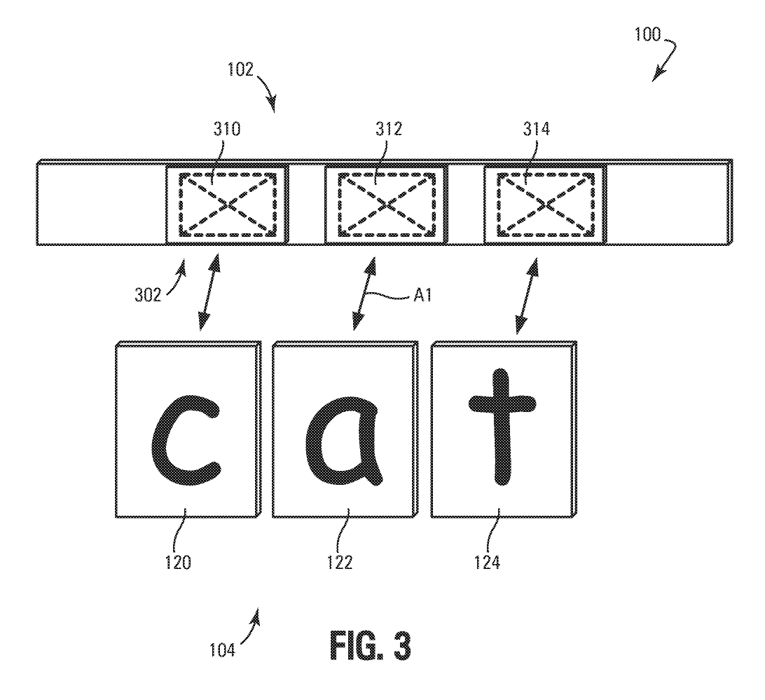

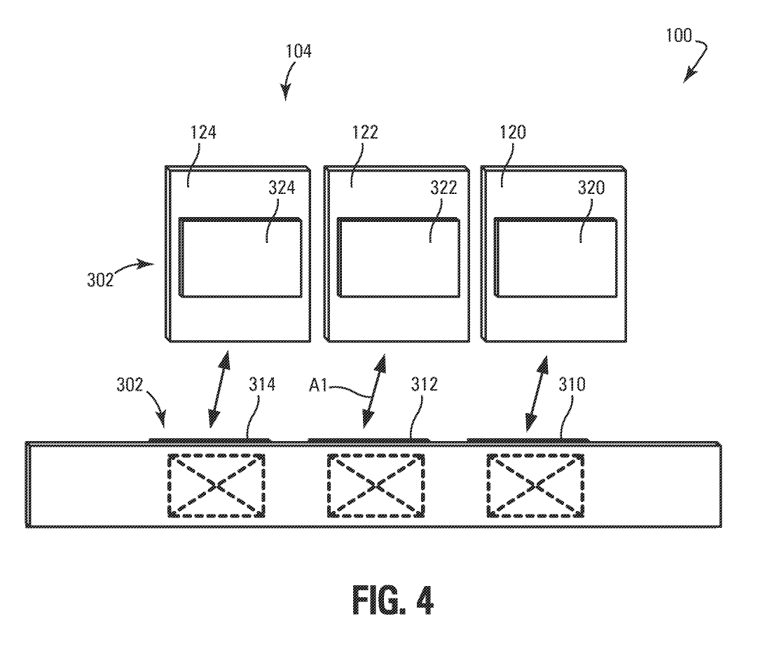

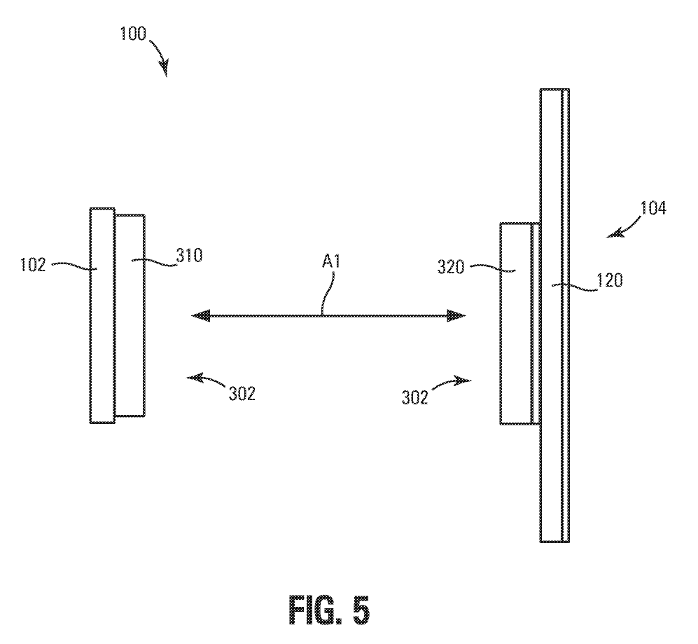

FIGS. 3-5 illustrate another example reading education tool 100 according to the present disclosure. FIG. 3 is an exploded front perspective view. FIG. 4 is an exploded rear perspective view. FIG. 5 is a left side view. In this example, reading education tool 100 includes separable fasteners.

Reading education tool 100 includes elastic strip 102 and letter pieces 104. Elastic strip 102 includes ends 110 and 112. In this example, letter pieces 104 include letter pieces 120, 122, and 124. Reading education tool 100 also includes fasteners 302. In some embodiments fasteners 302 include a first portion 310, 312, 314 (shown in FIG. 3) and a second portion 320, 322, and 324 (shown in FIG. 4).

Some embodiments of reading education tool 100 include three fasteners 302 for attaching up to three letter pieces 104 to elastic strip 102. Other embodiments include other quantities of fasteners, such as a quantity of fasteners in a range from about 1 to about 10, and preferably from about 3 to about 5, and more preferably 3 to 4.

In this embodiment, fasteners 302 include first and second portions that are separable to allow letter pieces 104 to be removed from elastic strip 102. Fasteners 302 also allow letter pieces to be connected to elastic strip 102.

One example of fastener 302 is a hook-and-loop fastener, such as the VELCRO ® brand hook-and-loop fastener. In some embodiments the first portion 310, 312, and 314 is a material including a plurality of hooks. The second portion 320, 322, and 324 is a corresponding material including a plurality of loops. The hooks of the first portion 310, 312, and 314 are engagable with the loops of the second portion 320, 322, and 324 to securely connect the first and second portions together. After the first and second portions have been connected together, the first and second portions are then separable. To do so, a separation force is applied by the user in the direction of arrows Al to cause the hooks to release the loops. In this way the letter pieces can be separated from the elastic strip 102. In an alternate embodiment the first portion has a plurality of loops and the second portion has a plurality of hooks.

Other embodiments include other types of separable fasteners. For example, another separable fastener is a pair of oppositely polarized magnets where first portions 310, 312, and 314 are a first magnet having a first polarity and portions 320, 322, and 324 are a second magnet having an opposite polarity such that the first and second magnets attract each other. Another example of a separable fastener is a magnet and a ferromagnetic material. In this example, first portions 310, 312, and 314 include a magnet and second portions 320, 322, and 324 include a ferromagnetic material that is attracted to the magnet when in close proximity to the magnet. Other examples of a separable fastener include a snap, a button and button hole, a zipper, a piece of tape, a non-permanent adhesive, a suction cup and a smooth nonporous material, a clip, or other connectable fasteners that are subsequently separable from each other. In some embodiments a separable fastener is separable without being permanently damaged (e.g., breaking, tearing, ripping, or permanently deforming). As discussed in more detail below, some embodiments of reading education tool 100 use one or more permanent fasteners to permanently connect first portions 310, 312, and 314 to elastic strip 102 and to permanently connect second portions 320, 322, and 324 to letter pieces 104.

As discussed above, some embodiments include permanent fasteners, such as thread sewn between two materials. Other embodiments include other permanent fasteners, such as an adhesive. In some embodiments a permanent fastener is not separable without causing permanent damage to the fastener or attached materials.

An advantage of some embodiments of reading education tool 100 is that a single reading education tool 100 can be used to teach a reader to read a wide variety of words. For example, a set of letter pieces including various letters is provided in some embodiments (such as shown in FIG. 9). A user selects certain letter pieces from the set and arranges them on elastic strip 102 to form a word. The reader then uses reading education tool 100 to learn to read that word. Once that word is known, the letter pieces 104 can be removed and another word can be arranged on the elastic strip 102 from other letter pieces 104.

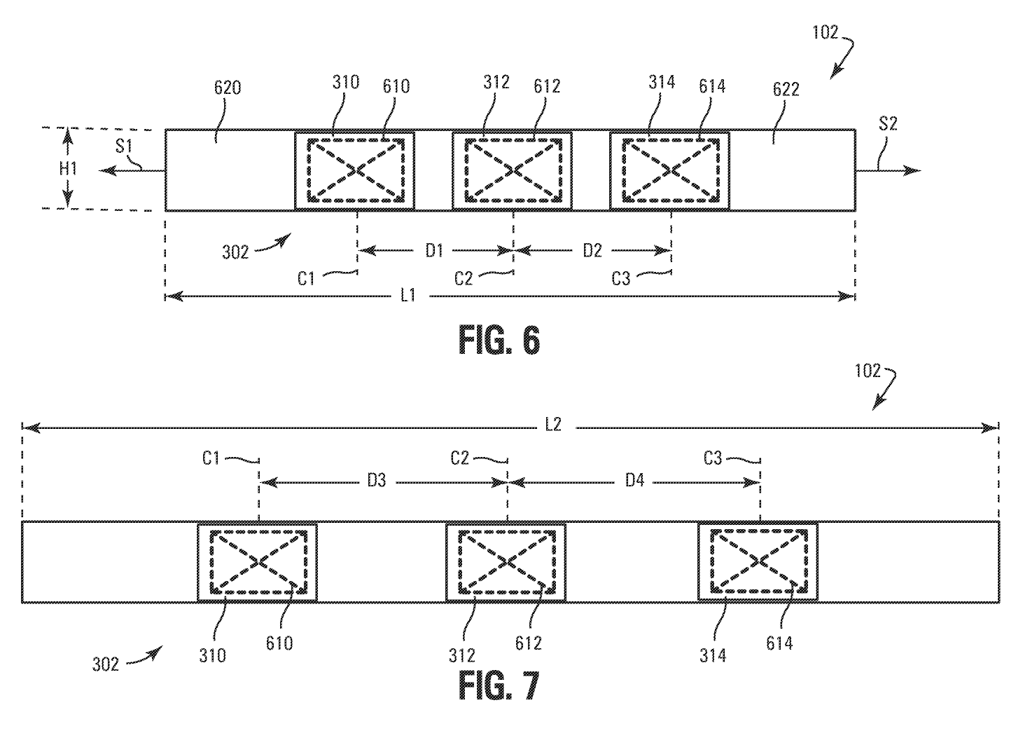

FIGS. 6-7 illustrate an example elastic strip 102 of the reading education tool 100, shown in FIG. 1. FIG. 6 is a front view of the elastic strip 102 in a relaxed position. FIG. 7 is a front view of the elastic strip 102 in a stretched position.

In some embodiments, first portions 310, 312, and 314 of fasteners 302 are connected to elastic strip 102. In this example, fasteners 302 are separable fasteners including first and second portions, as discussed above. Some embodiments also include permanent fasteners 610, 612, and 614.

First portions 310, 312, and 314 of fasteners 302 are configured to engage with second portions of fasteners (such as shown in FIG. 4). In some embodiments first portions 310, 312, and 314 are fastened to elastic strip 102 by permanent fasteners 610, 612, and 614. In one example, permanent fasteners 610, 612, and 614 are thread that is stitched through first portions 310, 312, and 314 and elastic strip 102. The thread is typically knotted at the ends. Any suitable stitching pattern may be used. In some embodiments first portions 310, 312, and 314 are only connected to elastic strip 102 about at or around a vertical centerline (c1, c2, and c3) of the first portions 310, 312, and 314. An advantage of such embodiments is it maintains more of the elasticity of the elastic strip 102. In another embodiment, first portions 310, 312, and 314 are connected near the periphery of first portions 310, 312, and 314. For example, some embodiments include a first stitching pattern near to the perimeter of first portions 310, 312, and 314 and further include an x-shaped stitching pattern inside of the first stitching pattern for added reinforcement. Other embodiments include other stitching patterns. Yet other embodiments include other permanent fasteners, such as adhesive.

In another possible embodiment, elastic strip 102 is or includes the first portion of fastener 302. For example, in some embodiments elastic strip 102 has a surface having a plurality of loops that are engagable by a second portion having a plurality of hooks. As another example, in some embodiments elastic strip 102 has a smooth non-porous surface, such that it is engagable by a second portion including a suction cup. In other possible embodiments elastic strip 102 includes multiple layers, where one layer is the first portion. In yet other embodiments first portions 310, 312, and 314 are contained within elastic strip 102.

Dimensions are described below with reference to example embodiments. Other embodiments include other dimensions outside those discussed below. H1, shown in FIG. 6, is a height of elastic strip 102. H1 is typically in a range from about 0.2 inches to about 4 inches, and preferably from about 0.5 inches to about 1 inch. L1, shown in FIG. 6, is a length of elastic strip 102 in the relaxed position. L1 is typically in a range from about 4 inches to about 18 inches, and preferably from about 6 inches to about 10 inches. L2, shown in FIG. 7, is a length of elastic strip 102 in the stretched position. L2 is typically in a range from about 5 inches to about 30 inches.

Elastic strip 102 includes an amount of elasticity E. E is a percentage elongation of elastic strip 102 from the relaxed position shown in FIG. 6 to the stretched position shown in FIG. 7, and is computed by dividing L2 by L1. E is typically in a range from about 120 percent to about 170 percent, and preferably in a range from about 140 percent to about 160 percent.

The elasticity of elastic strip 102 allows letter pieces to be separated when elastic strip 102 is in the stretched position. D1 is the distance between centerlines C1 and C2 of first portions 310 and 312 when in the relaxed position shown in FIG. 6. D2 is the distance between centerlines C2 and C3 of first portions 312 and 314 when in the relaxed position shown in FIGS. 6. D1 and D2 are typically in a range from about 0.5 inches to about 4 inches, and preferably from about 1 inch to about 2 inches.

When elastic strip 102 is stretched, as shown in FIG. 7, the distance between centerlines of first portions 310, 312, and 314 expands. D3 is the distance between centerlines C1 and C2 of first portions 310 and 312 when in the stretched position shown in

FIG. 7. D4 is the distance between centerlines C2 and C3 of first portions 312 and 314 when in the stretched position shown in FIGS. 7. D3 and D4 are typically in a range from about 1 inch to about 6 inches, and preferably from about 2 inches to about 3 inches. Therefore, when a letter piece is connected to elastic strip 102, the distance between letter pieces is greater when reading education tool 100 is in the stretched position than when reading education tool 100 is in the relaxed position. This separation allows a reader to more easily focus on each individual letter of a word, when reading education tool 100 is in the stretched position, but also allows the reader to view the word as a whole when reading education tool 100 is in the relaxed position.

In some embodiments elastic strip 102 is configured to include end tabs 620 and 622 at opposite ends of elastic strip 102. End tabs 620 and 622 provide a region where elastic strip 102 can be conveniently grasped, such as between a thumb and an index finger. For example, a reader grasps end tab 620 with a left hand and end tab 622 with a right hand. The reader holds reading education tool 100 (shown in FIG. 1) in the relaxed position to view an entire word made up of the letter pieces. The user then applies a separation force Si and S2 to end tabs 620 and 622 to place reading education tool into the stretched position. The reader then gradually releases the force Si and S2. The elasticity of elastic strip 102 causes reading education tool 100 to return to the relaxed position.

It should be understood that additional structure may be provided in the region where the elastic strip 102 can be grasped may be added to further ease use of the reading education tool 100 without departing from the scope of the disclosure. For example, a loop of material could be used as a handle to assist smaller children or those with less dexterity to operate the reading education tool 100. Other such structures are within the scope of one of skill in the art.

In some embodiments elastic strip 102 has a bright color. For example, some embodiments of elastic strip 102 are a bright red. Other embodiments have other colors or patterns of multiple colors. Some embodiments of elastic strip 102 have a color that contrasts with letter pieces 104.

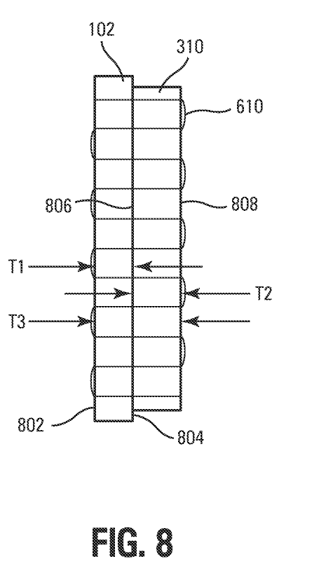

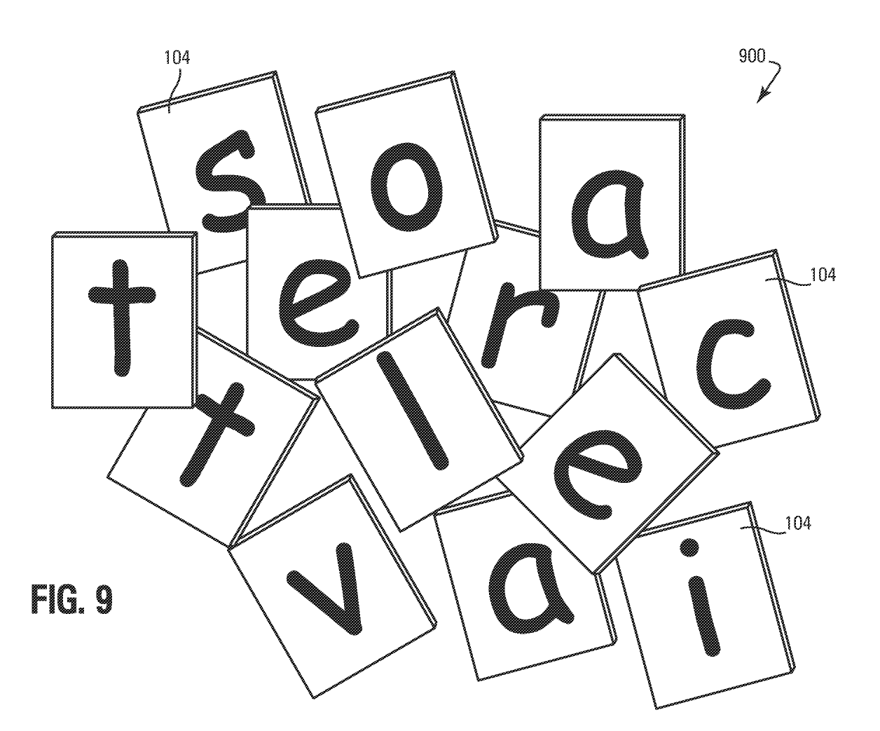

FIG. 8 is a left side cross-sectional view of an example elastic strip 102 and first portion 310 of fastener 302. In this example, elastic strip 102 includes a back surface 802 and a front surface 804. First portion 310 includes a back surface 806 and a front surface 808. Permanent fastener 610 is included in some embodiments.

A process of forming portions of reading education tool 100 is illustrated in FIG.

8. The process begins by arranging back surface 806 of first portion 310 so that it contacts front surface 804 of elastic strip 102. A permanent fastener 610 is then used to permanently connect elastic strip 102 with first portion 310. In some embodiments permanent fastener 610 is thread that is sewn into first portion 310 and elastic strip 102, as shown. Other embodiments include other fasteners. For example, an adhesive is used to fasten first portion 310 with elastic strip 102 in some embodiments.

Once assembled, letter pieces (shown in FIG. 9) are selectively connected to front surface 808 of first portion 310.

Although only first portion 310 is shown in FIG. 8, other first portions (e.g., first portions 312 and 314 shown in FIGS. 6-7) are similarly arranged in some embodiments.

Example dimensions for one embodiment of reading education tool 100 are provided below. Other embodiments include other dimensions. T1 is the thickness of elastic strip 102 when in the relaxed position. T1 is typically in a range from about 0.001 inches to about 0.5 inches, and preferably from about 0.01 inches to about 0.05 inches. T2 is the thickness of first portion 310 of fastener 302, such as a portion of a hook-and-loop fastener. T2 is typically in a range from about 0.001 inches to about 0.5 inches, and preferably from about 0.01 inches to about 0.2 inches. T3 is the overall thickness of reading education tool 100 not including letter pieces 104. T3 is typically in a range from about 0.002 inches to about 1 inch, and preferably from about 0.02 inches to about 0.25 inches.

FIG. 9 is top plan view of an example set 900 of letter pieces 104 of the reading education tool 100 shown in FIG. 1. Set 900 includes a plurality of letter pieces 104. In some embodiments, reading education tool is sold with set 900 of letter pieces 104. Set 900 includes multiple letter pieces. In some embodiments, the quantity of letter pieces 104 in set 900 is in a range from about 3 letter pieces to about 100 letter pieces, and preferably from about 10 letter pieces to about 50 letter pieces.

Letter pieces 104 typically include a representation of at least one letter. For example, some letter pieces 104 include a representation of vowels. Other letter pieces include a representation of consonants. Yet other letter pieces include representations of lower case letters. Further letter pieces include representations of capital letters. Examples of letters include the 26 letters of the English alphabet. Some letter pieces include other symbols, such as punctuation marks. Other embodiments include letter pieces having letters from other languages, such as Russian, German, Swedish, Norwegian, Chinese, Japanese, Korean, or other languages.

Some embodiments include letter pieces 104 that represent a digraph. A digraph is typically two characters that represent a distinct sound (phoneme) or sequence of sounds that do not correspond to the normal sounds of the characters. An example of a digraph is “ch”, such as used in the word “chick.” Because the combination of these two letters does not typically represent the sound made by the letters individually (the “c” sound plus the “h” sound), it is useful for the reader to learn the sound made by the digraph separate from the individual letters.

Some embodiments of reading education tool 100 include more than one letter piece 104 that represent the same letter. For example, some embodiments include two or more of the letter “e”. This is useful in forming words having more than one of the particular letter, such as the word “bee” that includes two of the letter “e”. This is also useful in some embodiments to provide replacement letters in the event that one becomes lost or damaged. It is also useful in some embodiments that include multiple elastic strips 102 so that multiple reading education tools may be used at a single time or in different places.

Some letter pieces 104 do not represent a letter. For example, some letter pieces 104 are blank. A user may subsequently write or print the letter onto the letter piece 104, for example. A blank letter piece is useful in some embodiment as a spare letter piece. If a particular letter piece is lost, the blank letter piece can be used as a substitute for the lost letter piece by writing the letter of the lost piece onto the blank letter piece.

In another embodiment, a blank letter piece is useful to allow a reader to think about what letter could be put in place of the blank letter piece to form a word. For example, if the following letter pieces are arranged on reading education tool 100: “c” and “a” followed by a blank letter piece, the reader can try to come up with all of the words that could be made by replacing the blank letter piece with a letter. Examples include the words: “car”, “cap”, “cat”, and “can.”

In some embodiments the quantity of each letter included in set 900 is proportional to how commonly the letters are used in the English language (e.g., there are more letter pieces that represent the letters “s” and “t” than letter pieces that represent the letters “q” and “z”. In other embodiments the quantity of each letter included in set 900 is proportional to how commonly the letters are used in an appropriate reading level vocabulary (e.g., first grade). In other embodiments, set 900 includes only those letters that are commonly used in the vocabulary of a particular reading level.

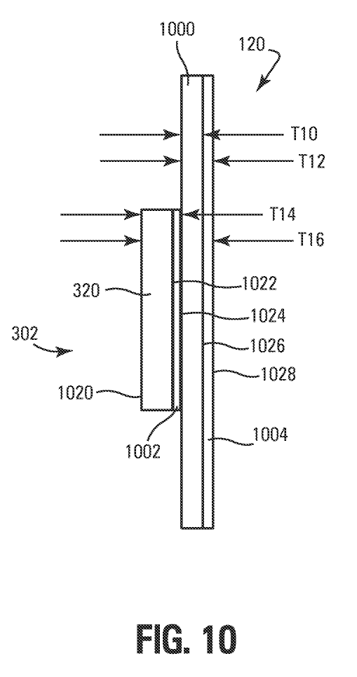

FIG. 10 is a left side cross-sectional view of an example letter piece 120 according to the present disclosure. In some embodiments, other letter pieces (e.g., any of letter pieces 104) are the same as letter piece 120. Other embodiments of letter pieces 104 have different arrangements or configurations.

In this example, letter piece 120 includes a backer layer 1000 and second portion 320 of fastener 302. Further, some embodiments of letter piece 120 include permanent fastener 1002 and ink layer 1004. Second portion 320 includes a back surface 1020 and a front surface 1022. Backer layer 1000 includes a back surface 1024 and a front surface 1026. Letter piece 120 includes a face 1028.

Backer layer 1000 is typically a sheet, plate, or piece of material on which a representation of a letter is applied. One example of backer layer 1000 is a sheet of paper (such as a material made of cellulose pulp, including paper, paperboard, cardboard, and card stock). Another example of backer layer 1000 is a sheet or piece of wood or wood-based material (e.g., plywood or particle board). Another example of backer layer 1000 is a metal piece or sheet. Further examples of backer layer 1000 include a piece of fabric or cloth (including felt or cotton or other fabric or cloth materials). Some embodiments of backer layer 1000 include multiple layers. Other embodiments include other backer layers or combinations of backer layers. In some embodiments backer layer 1000 includes a protrusion or indentation in the shape of a letter. The protrusion or indentation allows the reader to feel the shape of the letter or symbol in some embodiments.

Letter piece 120 typically includes a representation of a letter or symbol. In this example, backer layer 1000 includes an ink layer 1004 applied to front surface 1026 of backer layer 1000. In some embodiments ink layer 1004 is printed onto front surface 1026. In other embodiments, ink layer 1004 is written (such as with a marker, pen, or pencil) or painted onto front surface 1026. In some embodiments ink layer 1004 includes multiple layers, such as ink and a protective coating. Contact paper or a laminate is used as a protective coating in some embodiments. The protective coating surrounds backer layer 1000 (including back surface 1024 and front surface 1026) in some embodiments. Some embodiments of ink layer 1004 include an embossed ink layer, such as to allow the reader to feel the shape of the letter or symbol.

In some embodiments letter piece 120 includes a second portion 320 of fastener 302 that is coupled to backer layer 1000. As one example, front surface 1022 of second portion 320 is fastened to back surface 1024 of backer layer 1000. A permanent fastener 1002 is used in some embodiments to connect second portion 320 to backer layer 1000. An example of a permanent fastener 1002 is adhesive. Another embodiment of permanent fastener 1002 is double sided tape. Another possible embodiment of permanent fastener 1002 is thread sewn to connect backer layer 1000 and second portion 320. Preferably, the thread does not penetrate entirely through backer layer 1000 so that it is not visible at face 1028 of letter piece 120.

As discussed above, back surface 1020 is selectively engagable with front surface 808 (shown in FIG. 8) of first portion 310 to connect letter piece 120 with elastic strip 102 (as shown in FIG. 1).

Example dimensions for one embodiment of reading education tool 100 are provided below. Other embodiments include other dimensions. T10 is a thickness of backer layer 1000. T10 is typically in a range from about 0.0001 inches to about 0.3 inches, and preferably from about 0.001 inches to about 0.2 inches. T12 is the overall thickness of letter piece 120. T12 is typically only slightly larger than T10. In some embodiments, however, ink layer 1004 includes an embossing or protective layer. In such embodiments, T12 is typically in a range from about 0.00001 inches to about 0.001 inches larger than T10. T14 is the thickness of second portion 320 of fastener 302, such as a portion of a hook-and-loop fastener. T14 is typically in a range from about 0.001 inches to about 0.5 inches, and preferably from about 0.01 inches to about 0.2 inches.

T16 is the overall thickness of letter piece 120. T16 is typically in a range from about 0.001 inches to about 0.8 inches, and preferably from about 0.01 to about 0.05 inches.

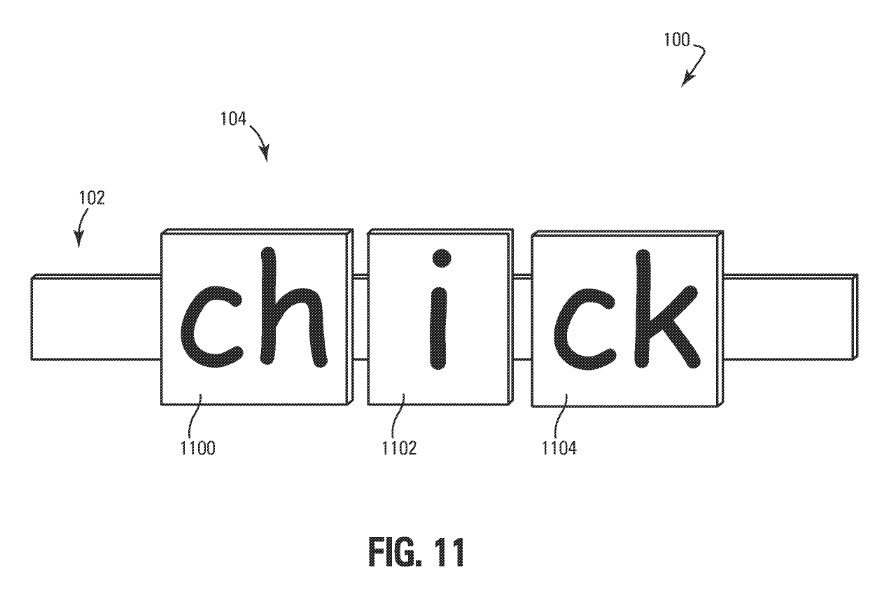

FIG. 11 is a front perspective view of another example reading education tool 100 according to the present disclosure. Reading education tool 100 includes elastic strip 102 and letter pieces 104. In this example, letter pieces 104 include letter pieces 1100, 1102, and 1104.

This example illustrates letter pieces 104 including a representation of one or more letters per letter piece 104. As discussed above, some embodiments of letter pieces 104 include a representation of a digraph, such as two letters that represent a single sound or set of sounds that are different than the combination of the sounds from the letters individually.

For example, letter piece 1100 includes the digraph “ch” that is different than the sounds represented by combination of the letters “c” and “h” individually. Letter piece 1102 include the letter “i”. Letter piece 1104 includes the digraph “ck” that has a single sound, rather than the double sound that would be produced by combining the sounds represented by the letters “c” and “k” individually.”

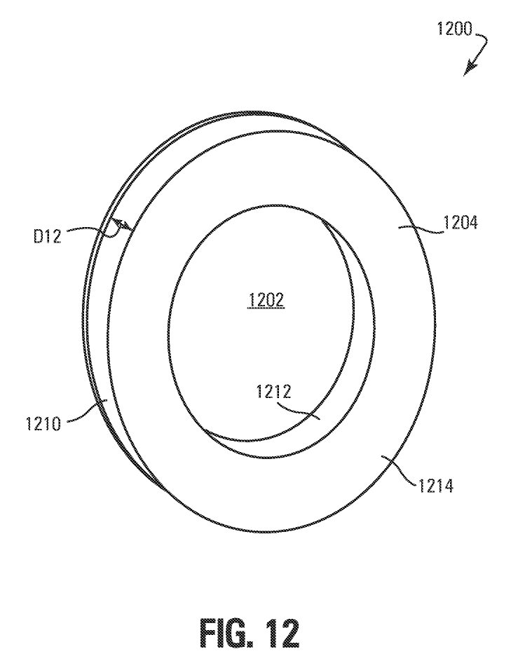

Reading education tool 100 is stretched by a reader to the stretched position to examine each letter piece 1100, 1102, and 1104 individually to consider the sound made by each digraph or letter. Once the individual sounds have been identifies, the reader returns the reading education tool 100 to the relaxed position (shown in FIG. 12) to view the word as a whole, while combining the sounds to pronounce the entire word or an approximation of the word.

Other examples of digraphs include the following: ci, gh, ng, ph, qu, rh, sc, sh, th, wh, wr, ea, ie, ai, ei, au, eu, ou, aw, ew, and ow. Some embodiments include other letter combinations, such as ii, ll, ee, ss, and oo.

Another possible embodiment separates words into syllables. Each syllable is provided on a separate letter piece 104. For example, the word “water” is made up of two letter pieces. The first letter piece includes the first syllable “wa” and the second letter piece includes the second syllable “ter.”

Some embodiments of letter pieces 104 are colored. For example, in some embodiments consonants have a first color (such as blue) and vowels have a second color (such as red). In other embodiments, rather than the letters being colored, the area surrounding the letters (i.e., the background) is colored.

FIG. 12 is a front perspective view of another example letter piece 1200 according to the present disclosure. Letter piece 1200 is an example of a three-dimensional letter piece. In this example, letter piece 1200 represents the letter “o”.

Letter piece 1200 includes backer layer 1202 and three-dimensional letter portion 1204. Three-dimensional letter portion 1204 includes outer sidewall 1210, inner sidewall 1212, and face 1214. Some embodiments include more or less sidewalls. For example, a capital letter “B” can include two inner sidewalls in some embodiments. Recessed regions are defined by inner sidewall(s) 1212.

In some embodiments backer layer 1202 is the same or similar to backer layer 1000 shown in FIG. 10. Letter portion 1204 is coupled to a front surface of backer layer 1202, such as by a permanent fastener. A fastener or fastener portion (not visible in FIG. 12) is connected to a back side of backer layer 1202 in some embodiments as discussed herein. Some embodiments do not include backer layer 1202. For example, the fastener or fastener portion is connected directly to letter portion 1204 in some embodiments.

Three-dimensional letter portion 1204 includes a three-dimensional representation of a letter, symbol, or combination of letters or symbols. Three-dimensional letter portion 1204 is made of a foam material in some embodiments. Other embodiments of letter portion 1204 are made of other materials, including paper, cardboard, card stock, particle board, plywood, wood, plastic, fabric, or other materials or combinations of materials. In some embodiments a protective layer or coating is also provided. An ink layer is printed on face 1214 in some embodiments but not in other embodiments.

The three-dimensional portion 1204 includes a thickness D12. The thickness D12 is typically in a range from about 0.1 inches to about 2 inches, and preferably from about 0.2 inches to about 0.5 inches.

In some embodiments face 1214 is substantially smooth and flat. In other embodiments, face 1214 has a substantially smooth and curved surface that merges with sidewalls 1210 and 1212. Yet other embodiments include a textured surface at face 1214. The textured surface provides increased tactile sensation. Various textures can be provided on face 1214, including an arrangement of bumps or protrusions, a smooth or felt-like texture, a rough or sandy texture, a fabric texture, or other textures.

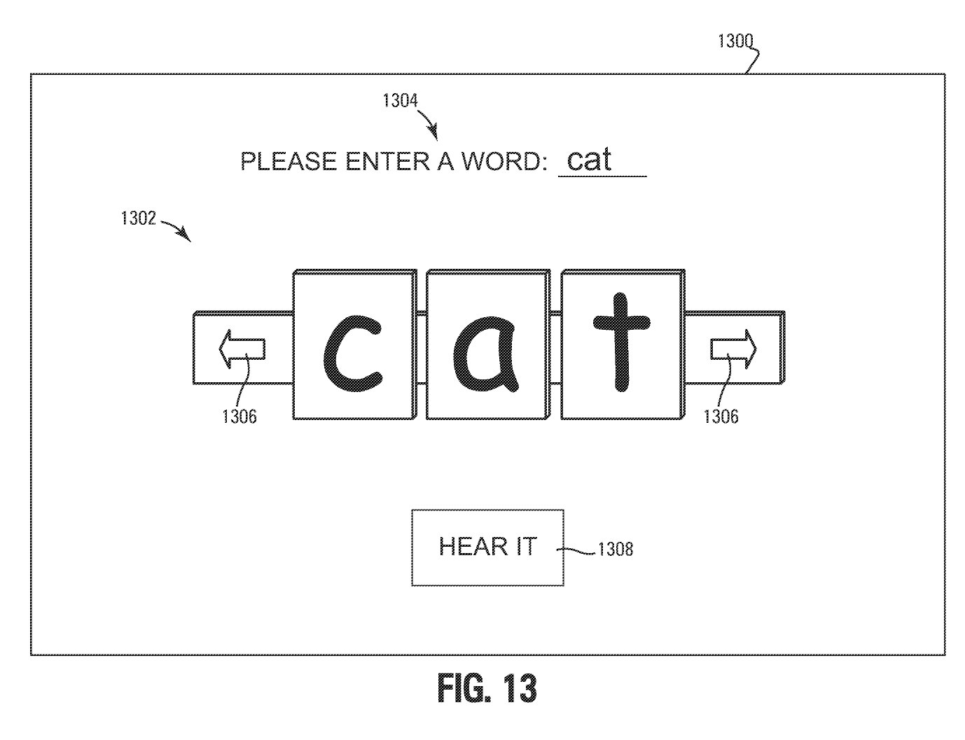

FIG. 13 is a screen shot of an example user interface display 1300 of a software program according to the present disclosure.

In some embodiments the software program is executable on computing device. An example of a computing device is a desktop computer. Other examples of computing devices include a laptop computer, a handheld computer, a cell phone, a personal digital assistant, a BLACKBERRY ® smartphone, and an IPHONE ® mobile digital device. A computing device typically includes a processor and memory. The computing device also typically includes an input device for receiving input from a user and an output device for outputting information to the user. Examples of input devices include a mouse, a keyboard, a keypad, a microphone, a touch-screen display, or other input devices. Examples of output devices include a computer monitor, a display device, a speaker, a projector, or other output devices. Some embodiments further include a communication device, such as a network communication device or wireless communication device.

Further, some embodiments include computer readable storage medium, such as a memory device. Examples of memory devices include memory cards, hard disc drives, compact discs (CDs), digital versatile discs (DVDs), or other devices capable of storing digital data. Data stored on a memory device is typically readable by the processor. Software stored on a computer readable storage medium is typically executable by the processor, such as to perform operations or methods described herein.

An example user interface display 1300 is shown in FIG. 13 as defined by a software program. The user interface display 1300 includes a representation 1302 of a reading education tool (previously discussed herein). User interface display 1300 further includes word prompt 1304, stretch buttons 1306, and hear it button 1308.

An example method is now described. The method begins with a first operation in which user interface display 1300 prompts a user to enter a word using word prompt 1304. In this example, word prompt 1304 says “Please Enter A Word”. The user then uses an input device to enter a word, such as the word. The word is received by the computing device and displayed in word prompt 1304. In some embodiments the word is entered by a reading instructor. In other embodiments the word is entered by a reader. In yet other embodiments the word is selected from a list of words automatically by the computing device.

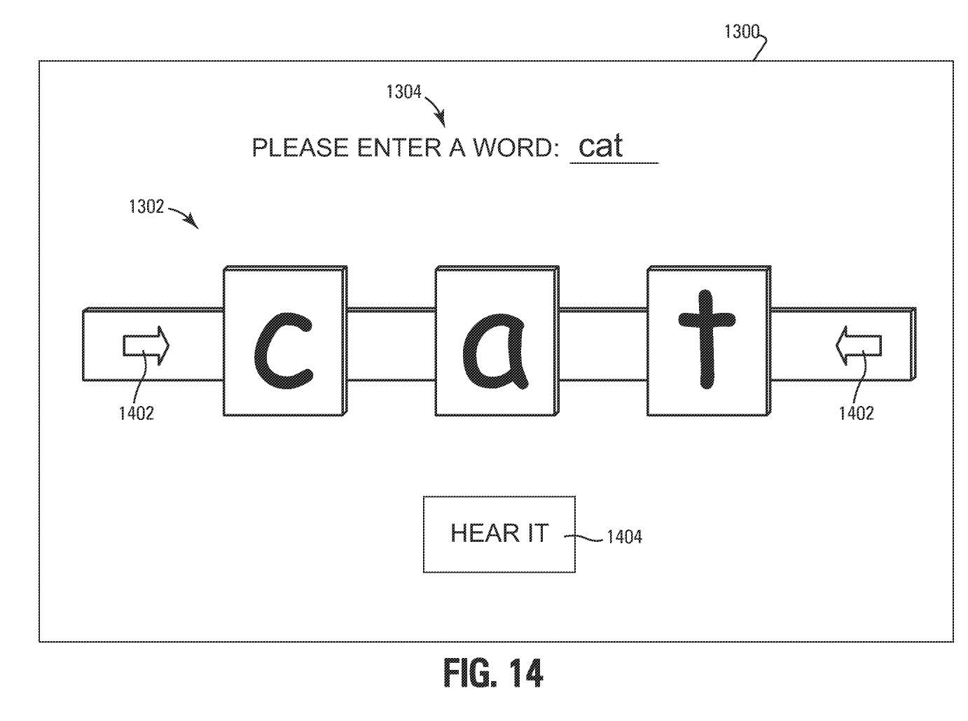

A next operation is then performed to display representation 1302 of the reading education tool including letter pieces corresponding to the word entered. In this example, letter pieces including the letters “c”, “a”, and “t” are displayed corresponding to the word “cat.” The representation 1302 of the reading education tool is first shown as being in a relaxed position, as illustrated in FIG. 13. However, in other embodiments the representation 1302 of the reading education tool is first shown as being in a stretched position, as illustrated in FIG. 14.

Some embodiments include a “hear it” button 1308. The hear it button 1308 can be selected by the user to request that the computing device read the word audibly. When the hear it button 1308 is selected, an operation is performed to output an audible representation of the word as a whole. In some embodiments the operation involves playing a recording of a person reading the word. In other embodiments the operation involves outputting an audible computer-generated representation of the word.

When the representation 1302 of the reading education tool is displayed in representation 1302 in the relaxed position, stretch buttons 1306 are displayed. The stretch buttons 1306 are arranged on end tabs of the elastic strip, the same place that a user would grasp a physical reading education tool to stretch the reading education tool. A user can select stretch buttons 1306 to cause user interface display 1300 to simulate stretching of reading education tool to the stretched position, as shown in FIG. 14.

FIG. 14 is a screen shot of the example user interface display 1300 in which the representation 1302 of the reading education tool is shown in the stretched position.

When in the stretched position, representation 1302 of the reading education tool graphically increases the separation of the letter pieces in the user interface display and increases the length of the elastic strip. This simulates stretching of a physical reading education tool.

In some embodiments, when representation 1302 is in the stretched position, user interface display 1300 includes relax buttons 1402 and hear it button 1404. Relax buttons 1402 are arranged on end tabs of the elastic strip of the reading education tool, the same location that a user would grasp if holding a physical reading education tool. The user can select buttons 1402. Once selected, the user interface display 1300 operates to simulate movement of the representation 1302 of the reading education tool from the stretched position to the relaxed position shown in FIG. 13.

While representation 1302 is in the stretched position, the user can select hear it button 1404. When selected, the software outputs audible sounds that relate to the individual letter pieces. In one example, the software states the name of a letter or group of letters on a letter piece and then outputs the sound represented by the letter or group of letters. The same process repeats for each letter piece. In another example only the sounds represented by each letter piece are output. In another example only the name of the letter is output. Other embodiments include other outputs. Some embodiments include a hear it button for each letter piece.

It is noted that that the user interface does not require all of the physical components of a physical reading education tool in all embodiments. For example, some embodiments of representation 1302 do not include a representation of an elastic strip. Some embodiments of representation 1302 do not include fasteners.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A reading education tool comprising:
an elastic strip having a relaxed position and a stretched position;
a first letter piece coupled to the elastic strip; and
a second letter piece coupled to the elastic strip, wherein when the elastic strip is in the stretched position, a distance between the first and second letter pieces is greater than when the elastic strip is in the relaxed position.

2. The reading education tool of claim 1, further comprising a quantity of letter pieces coupled to the elastic strip, wherein the quantity is in a range from about 3 to about 5.

3. The reading education tool of claim 1, further comprising a permanent fastener connected to the elastic strip and the first letter piece.

4. The reading education tool of claim 1, further comprising a separable fastener connected to the elastic strip and the first letter piece.

5. The reading education tool of claim 4, wherein the separable fastener is a fastener selected from the group consisting of a hook-and-loop fastener, a magnet, a pair of magnets, a magnet and a ferromagnetic material, a snap, a button and button hole, a zipper, a piece of tape, a non-permanent adhesive, a suction cup and a smooth non-porous material, and a clip.

6. The reading education tool of claim 4, wherein the separable fastener includes a first portion permanently connected to the elastic strip and a second portion permanently connected to the letter piece.

7. The reading education tool of claim 6, wherein the first portion is permanently connected to the elastic strip by a first permanent fastener and wherein the second portion is permanently connected to the letter piece by a second permanent fastener.

8. The reading education tool of claim 7, wherein the first and second permanent fasteners are selected from the group consisting of an adhesive and thread.

9. The reading education tool of claim 1, wherein letters associated with the letter pieces are distortion free when the reading education tool is in the stretched position.

10. A software program stored on a computer readable storage medium, the software program including instructions executable by a processor of a computing device to generate a user interface display, the user interface display comprising:
a visual representation of a reading education tool, the reading education tool including a plurality of spaced letter pieces, each letter piece associated with at least one letter, wherein the reading education tool includes a stretched position and a relaxed position, and wherein when the reading education tool is in the stretched position, a distance between adjacent letter pieces is greater than when the reading education tool is in the relaxed position.

11. The software program of claim 10, wherein the user interface display further comprises a stretch button, wherein when the stretch button is selected by a user, the visual representation of the reading education tool changes the reading education tool from the relaxed position to the stretched position.

12. The software program of claim 11, wherein the user interface display further comprises a relax button, wherein when the relax button is selected by the user, the visual representation of the reading education tool changes the reading education tool from the stretched position to the relaxed position.

13. The software program of claim 10, wherein the user interface display further comprises a hear it button, wherein when the hear it button is selected while the reading education tool is represented as being in the relaxed position, the software program causes the computing device to generate an audible sound associated with a word made up of a combination of letters of the letter pieces.

14. The software program of claim 10, wherein the user interface display further comprises a hear it button, wherein when the hear it button is selected while the reading education tool is represented as being in the stretched position, the software program causes the computing device to generate an audible sound associated with at least one of the letters of at least one of the letter pieces.

15. A reading education method, the method comprising:
arranging and connecting a plurality of letter pieces on a reading education tool while the reading education tool is in a relaxed position;
stretching the reading education tool to a stretched position to increase spaces between adjacent letter pieces of the plurality of letter pieces;
viewing the plurality of letter pieces while the reading education tool is in the stretched position;
allowing the reading education tool to return to a relaxed position; and
viewing the plurality of letter pieces while the reading education tool is in the relaxed position.

16. The reading education method of claim 15, further comprising identifying a sound made by at least one letter represented by each of the plurality of letter pieces while viewing the plurality of letter pieces while the reading education tool is in the stretched position.

17. The reading education method of claim 16, further comprising identifying a word by combining each of the sounds associated with each of the letter pieces while viewing the plurality of letter pieces while the reading education tool is in the relaxed position.
